(19) United States
(12) Patent Application Publication
(10) Pub. No.: US 2025/0038591 A1
(43) Pub. Date: Jan. 30, 2025

(54) ROTOR FOR A ROTARY ELECTRIC MACHINE

(71) Applicant: NIDEC PSA EMOTORS, CARRIERES SOUS POISSY (FR)

(72) Inventors: Andre DARABANA, VILLENNES SUR SEINE (FR); Diana FANTUZ, PLAISIR (FR); Jean Baptiste ROUX, VAUX SUR SEINE (FR); Guillaume TARDY, LA CELLE SAINT-CLOUD (FR)

(21) Appl. No.: 18/710,404

(22) PCT Filed: Nov. 16, 2022
(86) PCT No.: PCT/FR2022/052101

§ 371 Date: May 15, 2024

(30) Foreign Application Priority Data
Nov. 26, 2021 (FR) 2112560

(51) Int. Cl. H02K 1/22; H02K 15/02

(52) U.S. Cl. CPC H02K 1/22; H02K 15/02; H02K 2213/03

(57) ABSTRACT

A rotor of an electric machine, rotating about an axis of rotation X, the rotor comprising:—a shaft (9) arranged along the axis of rotation,—a rotor mass (3), disposed around the shaft, comprising:—a central bore (4),—at least two openings (5), provided in the rotor mass and distributed circumferentially around the central bore, the two openings leaving a radial strip (6) therebetween, the radial strip having a smaller width, at least one bridge of material (7) being provided between an opening and the central bore, the bridge of material being of variable width and having a greater width, and the ratio between the smaller width of the radial strip and the larger width of the bridge of material being between 0.75 and 1.25.

### CROSS-REFERENCE TO RELATED APPLICATIONS

This application is the US National Stage under 35 USC § 371 of International Application No. PCT/FR2022/052101, filed Nov. 16, 2022, which claims the priority of French application 2112560 filed on Nov. 26, 2021, the content (text, drawings and claims) of both said applications being incorporated by reference herein.

### BACKGROUND

The methods and devices described herein relate to rotary electric machines and, more particularly, to the rotors for such machines. They relate, in particular, to the assembly of the rotor on a shaft of the machine, and in particular to the connection between the shaft and a rotor mass of the rotor.

More particularly, they relate to synchronous or asynchronous AC machines. In particular, they relate to traction or drive machines for electric motor vehicles (Battery Electric Vehicle) and/or hybrid motor vehicles (Hybrid Electric Vehicle—Plug-in Hybrid Electric Vehicle), such as private cars, vans, trucks or buses. They also apply to rotary electric machines for industrial and/or power generation applications, in particular naval, aerospace or wind turbine applications.

It is known to produce a rotor comprising a connection between the shaft and the rest of the rotor.

Application US 2021/0006111 relates to a rotor mass comprising openings providing bridges of material of constant width with the central bore.

Applications US 2015/0137632, JP 2015073387, WO 2021/047725, US 2020/0244117, WO 2020/233736 disclose rotor masses comprising openings providing bridges of material of significant width with the central bore, particularly in relation to the strip of material between two consecutive openings. These rotor masses do not allow for sufficient deformation of the bridge of material when the rotor mass is inserted onto the shaft and held in position during rotation of the rotor.

However, in the case of machines intended to rotate at high rotational speeds, there is a risk that the rotor mass of the rotor will stretch under the effect of the speed, a phenomenon also called centrifugal expansion. In the case where the rotor mass is clamped onto the machine shaft, then the tightening must be increased in order to ensure sufficient contact pressure at high speed. Furthermore, excessively high fitting forces can, in certain cases, lead to deformation of the laminations of the rotor mass and/or deterioration of the external surface of the shaft.

There may also be greater electromagnetic interference, and a greater risk of sudden detachment, in the event of excessive torque or shocks.

There is therefore a need to benefit from a rotor of a rotary electric machine allowing easier and less expensive installation of the rotor mass on the shaft, and simpler and safer use.

### SUMMARY

The described methods and devices aim to meet this need and achieve this, according to one aspect, thanks to an electric machine rotor, rotating about an axis of rotation, the rotor comprising:
a shaft arranged along the axis of rotation,
a rotor mass, extending along the axis of rotation and disposed around the shaft, the rotor mass comprising:
a central bore for the passage of the shaft,
at least two openings, provided in the rotor mass and distributed circumferentially around the central bore, the two openings leaving a radial strip therebetween, the radial strip having a smaller width,
   at least one bridge of material being provided between an opening and the central bore, the bridge of material being of variable width and having a larger width and a smaller width, and
   the ratio between the smaller width of the radial strip and the larger width of the bridge of material being between 0.75 and 1.25, better still between 0.90 and 1.10, better still between 0.95 and 1.05, for example being of the order of 1.

The smaller width of the radial strip may be 25% greater, better still 10% greater, better still 5% greater than the larger width of the bridge of material. The smaller width of the radial strip may be 25% less, better still 10% less, better still 5% less than the larger width of the bridge of material. The smaller width of the radial strip and the larger width of the bridge of material may be substantially equal.

According to another of its aspects, the described methods and devices relate, independently or in combination with the foregoing, to a rotor of an electric machine, rotating about an axis of rotation, the rotor comprising:
a shaft arranged along the axis of rotation,
a rotor mass, extending along the axis of rotation and disposed around the shaft, the rotor mass comprising:
a central bore for the passage of the shaft,
at least two openings, provided in the rotor mass and distributed circumferentially around the central bore,
   at least one bridge of material being provided between an opening and the central bore, the bridge of material being of variable width and having a greater width and a smaller width,
   the ratio between the larger width and the smaller width of a bridge of material being between 1.10 and 3.00, better still between 1.25 and 2.50, better still between 1.30 and 1.70, being for example of the order of 1.35.

“Width of the radial strip” is understood to mean the distance between two edges of the radial strip measured in the circumferential direction. The edges of the radial strip are defined by the openings.

“Width of the bridge of material” is understood to mean the distance between two edges of the bridge of material measured in the radial direction. The edges of the bridge of material are defined, on the one hand, by the central bore and, on the other hand, by the corresponding opening.

Such a ratio allows elastic and/or plastic deformation of the bridge of material. The deformation of the bridge of material may not be solely plastic. The deformation of the bridge of material may not be solely elastic. The deformation of the bridge of material may be elastic and plastic.

The bridge of material can be deformed out of a plane perpendicular to the axis of rotation when the rotor mass is inserted onto the shaft, particularly at the edge of the central bore.

The bridge of material can also deform in a plane perpendicular to the axis of rotation. In particular, the bridge of material can move radially slightly outwards. This elastic and/or plastic deformation makes it possible to improve the flexibility of the rotor mass at the time of its insertion onto the shaft by fitting, in particular by shrink-fitting.

A rotor makes it possible to interlock the assembly formed by the rotor mass and the shaft at high speeds. It thus makes it possible to limit the impact of the centrifugal load compared to a simple press-fit in order to secure the rotor mass to the shaft. In particular, the openings arranged above the bridges of material make it possible to reduce the weight of the rotor mass by reducing the material and thus reduce the centrifugal effect on the bridge of material. The centrifugal load of the bridge of material can thus be reduced, which makes it possible to prevent the separation of the rotor mass from the shaft. The elastic return effect of the bridge of material solidifies the assembly between the rotor shaft and the rotor mass.

### Bridges of Material

The rotor can comprise a number of bridges of material, for example between 1 and 12. The rotor can in particular comprise an even number of bridges of material, for example the rotor can comprise 2, 4, 6, 8 or 10 bridges of material. Alternatively, the rotor can comprise an odd number of bridges of material, for example the rotor can comprise 1, 3, 5, 7 or 11 bridges of material.

The rotor can comprise a number of openings, for example between 1 and 12. The rotor can comprise an even number of openings, for example the rotor can comprise 2, 4, 6, 8 or 10 openings. Alternatively, the rotor can comprise an odd number of openings, for example the rotor can have 1, 3, 5, 7 or 11 openings.

The bridge of material can comprise areas of smaller width on either side of its larger width.

The areas of smaller width make it possible to reduce shearing which risks causing the rotor mass to separate from the shaft.

The ratio between the larger width of a bridge of material and the smaller width of a bridge of material can be between 1.10 and 3.00, better still between 1.25 and 2.50, better still between 1.30 and 1.70, being for example of the order of 1.35.

The smaller width of the bridge of material can be between 30 and 90%, better still between 50 and 80%, for example of the order of 75% of the larger width of the bridge of material.

The area of smaller width of the bridge provides sufficient rigidity to the bridge of material so that it does not deform too much out of its plane, particularly when the rotor mass is inserted onto the shaft.

At least one bridge of material, better still all the bridges of material, can be substantially symmetrical with respect to a radial plane containing the axis of rotation X of the rotor. At least one opening, better still all the openings, can be substantially symmetrical with respect to a radial plane containing the axis of rotation X of the rotor. The plane of symmetry of a bridge of material can meet the plane of symmetry of the opening providing this bridge of material.

A bridge of material may be devoid of a sharp edge. This makes it possible to avoid the concentration of stresses and thus increases the fatigue life of the zone. Rotor wear is therefore reduced.

### Tongue

A bridge of material can comprise one or more tongues arranged between areas of smaller width.

The tongue can in particular extend into the central bore.

The tongue(s) can be substantially centered around the larger width of the bridge of material. A plane of symmetry of the tongue can meet the plane of symmetry of the bridge of material and/or a plane of symmetry of the opening. The tongue(s) can be radially aligned with the opening(s). The tongue is arranged radially between the central bore and the opening.

Alternatively, the tongue(s) cannot be centered around the greater width of the bridge of material. A plane of symmetry of the tongue cannot meet a plane of symmetry of the bridge of material nor a plane of symmetry of the opening. A tongue can, for example, be offset by 10° relative to a plane of symmetry of the opening.

The tongue may not have a plane of symmetry.

The tongue(s) may not bend when the rotor mass is inserted onto the shaft. On the other hand, the tongues may deform out of the plane of the rotor mass lamination when the rotor mass is inserted onto the shaft. In addition, the curvature of the tongue in contact with the shaft is deformed when the rotor mass is inserted.

On the side of the central bore, the junction zone between the tongue and each of the adjacent areas of smaller width can be curved. The radius of curvature of the junction zone can be at least 0.1 mm, better still at least 0.2 mm, better still at least 0.3 mm, for example of the order of 0.35 mm.

The tongue can be shrink-fitted onto the shaft.

The circumferential dimension of the tongue can be between 1 and 40% of the diameter of the central bore, better still between 5 and 15%, for example of the order of 9% of the diameter of the central bore.

The circumferential dimension of the tongue corresponds to the circumferential dimension of the part of the bridge of material in contact with the shaft. The circumferential dimension of a tongue can be between 1 and 10 mm, better still between 2 and 5 mm, for example of the order of 3 mm.

“Circumferential dimension of the bridge of material” is understood to mean the distance measured circumferentially between two points of the bridge of material arranged in an area of width equal to the smaller width of the bridge of material. The circumferential dimension of a tongue can be between ⅓ and ½ of the circumferential dimension of the bridge of material.

Performing shrink-fitting over the entire internal diameter of the rotor mass could risk shearing the lamination during assembly. The areas of smaller width make it possible to clamp more tightly onto narrower shrink-fitted surfaces while avoiding shearing, which would cause the rotor mass to separate from the shaft.

The shaft can be substantially smooth, the shaft being notably devoid of surface roughness.

The shaft may be devoid of roughness on its exterior surface. In particular, the shaft may not comprise any grooves. Alternatively or additionally, the shaft may not be flat on its exterior surface. The shaft may be substantially circular in shape when viewed in cross section.

In one embodiment, the shaft may be made of a material with a hardness greater than 400 HV, better still greater than 500 HV, or even greater than 600 HV, being for example a hard steel with a hardness greater than 650 HV.

In one embodiment, the rotor mass can be made from a material with a hardness less than 300 HV, better still less than 250 HV, or even less than 220 HV, being for example of the order of 200 HV.

The tongues are not inserted into grooves in the shaft, which would inhibit the rotation of the rotor mass relative to the shaft.

The edge of the tongue on the side of the central bore may be convex, especially slightly convex. The radius of curvature of the edge of the tongue on the side of the central bore may be substantially equal to the radius of the central bore of the rotor mass. The radius of curvature of the edge of the tongue on the side of the central bore may be approximately equal to the radius of the shaft. The radius of curvature of the edge of the tongue on the side of the central bore may be between 5 and 200 mm, better still between 20 and 100 mm, better still between 30 and 50 mm, for example of the order of 33 mm or of the order of 43 mm. Alternatively, the edge of the tongue on the side of the central bore may be straight.

The edge of the tongue on the side of the opening may be concave. Alternatively, the edge of the tongue on the side of the opening may be straight.

### Recesses

The variations in the width of the bridge of material can form recesses around the larger width of the bridge of material, particularly at the edge of the central bore. The recesses can thus be arranged on either side of the tongue.

The variations in the width of the bridge of material can be such that the recesses formed around the larger width of the bridge of material can comprise curved portions formed in the edge of the central bore. The curved portions may be concave and/or convex portions. The recesses may for example have the shape of a crescent.

The radius of curvature of the curved portions of the recesses may be greater than 0.35 mm, better still greater than 1 mm, better still greater than 2 mm, better still greater than 3 mm, better still greater than 4 mm, for example of the order of 5 mm.

The recesses can provide a passage for cooling fluid between the shaft and the rotor mass. It is therefore not necessary to machine complex shapes, such as grooves in the shaft and/or rotor mass. The rotor is therefore more simple to manufacture and more economical.

The rotor offers more flexibility to ensure cooling via the rotor. The rotor is compatible with various cooling passageway shapes and arrangements and different cooling fluid distribution types.

The recesses also make it possible to release the stresses suffered by the bridge of material, and in particular on the tongue, by allowing its clastic and/or plastic deformation. The normal reaction force will push the tongue against the shaft to lock the assembly and hold it in place.

### Laminations

The rotor mass can be formed of a stack of laminations forming stacks, in particular laminations that are all substantially identical, namely at least identical on the side of the shaft.

The laminations may be cut in a tool, one after another. They can be stacked and clipped or glued into the tool, in complete stacks or sub-stacks. The laminations may be snap-fastened to one another. Alternatively, the stack of laminations can be stacked and welded outside the tool.

The laminations are magnetic. The laminations of the rotor mass can all be identical on the side of their cooperation with the shaft. In particular, the rotor mass may not be solid. The bridges of material and the tongues can be made of a single piece with the laminations.

The stack of laminations of the rotor mass can comprise laminations arranged in one direction and laminations in the other opposite direction. The laminations can be turned over in stacks, the stack of laminations of the rotor mass comprising alternate stacks of laminations arranged in one direction and stacks of laminations in the opposite direction. A more homogeneous distribution of stresses is thus obtained in the rotor. The performance of the machine is improved, particularly in terms of vibrations, noise and torque ripples.

At least a first and a second lamination of the stack of sheets can be angularly offset such that the tongues of the bridges of material of the first lamination are not aligned with the tongues of the bridges of material of the second lamination.

The first and second laminations can be angularly offset by an angle of between 1 and 10°,better still between 2 and 8°, better still between 3 and 5°, for example of the order of 3.75°.

At least a first and a second stack of laminations of the stack of laminations can be angularly offset so that the tongues of the bridges of material of the first stack are not aligned with the tongues of the bridges of material of the second stack.

The first and second stacks can be angularly offset by an angle of between 1 and 10°, better still between 2 and 8°, better still between 3 and 5°, for example of the order of 3.75°.

### Openings

The openings can have a greater circumferential dimension of between 5 mm and 100 mm, better still between 10 and 70 mm, better still between 15 and 40, for example of the order of 20 mm or 25 mm.

The circumferential dimension of the openings is sufficiently high so that the radial strips between the openings are sufficiently thin to allow the deformation of the bridges of material.

The circumferential dimension of an opening may be greater than its radial dimension. For example, the circumferential dimension of an opening can be equal to at least 1.1 times, better still at least 1.3 times, better still at least 1.5 times, better still at least 2 times its radial dimension.

Alternatively, the circumferential dimension of an opening can be less than its radial dimension. As a further variation, the circumferential dimension of an opening can be equal to a radial dimension. The openings may be substantially triangular, rectangular, circular, oval, oblong, trapezoidal or multi-lobed.

The openings can all be identical for the same lamination. Alternatively, at least two openings can be of different shapes and/or sizes. The openings can all be identical for the same lamination stack. Alternatively, at least two laminations of the same stack can have openings of different shapes and/or sizes.

The openings can also allow the passage of tie rods, in particular tie rods used to hold together the stack of laminations. The openings allow tie rods to be inserted and positioned at the outermost point to compress the stacks of laminations and to prevent the laminations from swelling.

The openings can also be used to circulate a cooling fluid, thereby improving rotor cooling.

The openings improve the mechanical strength of the rotor.

The shapes of the openings can be simple. The rotor mass laminations can thus be cut in a less complex manner and assembly can be more simple.

The internal circumference of an opening can comprise curved portions, for example circular portions. The curved portions can have a radius of curvature of at least 0.35 mm, better still at least 0.75 mm, better still at least 1 mm, better still at least 2 mm, better still at least 3 mm. As a variant or addition, the opening can include a rectilinear portion.

### Rotor

The rotor can comprise permanent magnets, in particular with surface or buried magnets. Permanent magnets can be arranged in housings.

The largest radial dimension of an opening may depend on the position of the magnet housings and in particular on their radial distance relative to the axis of rotation.

The radial distance between the edge of an opening furthest from the axis of rotation and a magnet housing arranged at the same circumferential position can be between 1 and 10 mm, better still between 2 and 7 mm, better still between 3 and 6 mm, for example of the order of 5 mm.

The smaller width 1b of the radial strip may be greater than or equal to the radial distance between the edge of an opening furthest from the axis of rotation and the magnet housings

The rotor may have a flow concentration. It may comprise one or several layers of magnets arranged in I, U or V.

Alternatively, it may be a wound or squirrel cage rotor, or a switched reluctance rotor.

The number of poles P on the rotor is for example between 4 and 48, being for example 4, 6, 8, 10 or 12.

The diameter of the rotor may be less than 400 mm, better still less than 300 mm, and greater than 50 mm, better still greater than 70 mm, being for example between 100 and 200 mm.

The housings of the permanent magnets can be made entirely by cutting into the laminations. Each lamination of the stack of laminations can be made of a single piece.

Each lamination is for example cut from a sheet of magnetic steel or containing magnetic steel, for example steel 0.1 to 1.5 mm thick. The laminations may be coated with an electrically insulating varnish on their opposite faces before they are assembled within the stack. The electrical insulation can also be obtained by heat treatment of the laminations, where appropriate.

As a variant, the rotor mass can be manufactured from a compacted or agglomerated magnetic powder.

The rotor magnetic mass may include salient poles. The poles can be made from the same piece as the rest of the rotor mass, or attached thereto.

The shaft can be made of a magnetic material, which advantageously makes it possible to reduce the risk of saturation in the rotor mass and to improve the electromagnetic performance of the rotor.

In one variant, the rotor includes a non-magnetic shaft on which the rotor mass is arranged. The shaft can be made at least in part from a material from the following list, which is not limited: steel, stainless steel, titanium or any other non-magnetic material.

In one embodiment, the rotor mass may be arranged directly on the non-magnetic shaft, for example without an intermediate rim. In one variant, particularly in the case where the shaft is not non-magnetic, the rotor may include a rim surrounding the rotor shaft and bearing thereupon.

The rotor mass may have an outer contour which is circular or multilobed, a multilobed shape potentially being useful for example to reduce the torque ripples or the current or voltage harmonics.

The rotor may be mounted so as to be cantilevered or not, relative to the bearings used to guide the shaft.

The rotor can be made of several stacks aligned in the axial direction, for example at least two stacks. Each of the stacks may be angularly offset relative to the adjacent stacks (“step skew”).

### Machine and Stator

The described methods and devices also relate, according to another aspect, independently or in combination with the foregoing, to a rotary electric machine comprising a rotor as disclosed above and a stator.

The machine may be used as a motor or as a generator. The machine may be a reluctance machine. It may be a synchronous motor or, alternatively, a synchronous generator. Alternatively still, it is an asynchronous machine.

The maximum rotational speed of the machine may be high, for example higher than 10,000 rpm, better still higher than 12,000 rpm, for example of the order of 14,000 rpm to 15,000 rpm, or even 20,000 rpm or 25,000 rpm. The maximum rotational speed of the machine may be lower than 100,000 rpm, or lower than 60,000 rpm, or even lower than 40,000 rpm, better still lower than 30,000 rpm.

The machine may include a single inner rotor or, alternatively, an inner rotor and an outer rotor, which are arranged radially on either side of the stator and are rotationally coupled.

The machine may be placed into a casing on its own or inserted in a gearbox casing. In this case, it is placed in a casing that also houses a gearbox.

The machine includes a stator. The stator includes teeth which define slots between them.

The stator can comprise electrical conductors. At least a part of the electrical conductors, or even a majority of the electrical conductors, may be in the form of U-or I-shaped pins.

The slots may be at least partially closed. A partially closed slot makes it possible to provide an opening at the air gap, which can be used for example to install the electrical conductors for filling the slot. A partially closed slot is in particular formed between two teeth which each include pole shoes at their free end, which close the slot at least in part.

Alternatively, the slots can be fully closed. The term “fully closed slot” denotes slots which are not open radially toward the air gap.

In one embodiment, at least one slot, or even each slot, can be continuously closed on the side of the air gap by a material bridge made from the same piece as the teeth defining the slot. All the slots can be closed on the side of the air gap by material bridges closing the slots. The material bridges may be made from the same piece as the teeth defining the slot. The stator mass in such a case has no cut between the teeth and the material bridges closing the slots, and the slots are then continuously closed on the side of the air gap by the material bridges made from the same piece as the teeth defining the slot.

Furthermore, the slots can also be closed on the side opposite the air gap by a yoke that is attached to or made from the same piece as the teeth. The slots are then not open radially outward. The stator mass may have no cut between the teeth and the yoke.

In one embodiment, each of the slots has a continuously closed contour. “Continuously closed” means that the slots have a continuous closed contour when they are observed in cross-section, taken perpendicular to the rotational axis of the machine. It is possible to go all the way around the slot without encountering a cut in the stator mass.

### Manufacturing Methods

The object is also, independently or in combination with the foregoing, a method for manufacturing a rotor as disclosed above, comprising the following steps:
(a) Provide a rotor shaft and a rotor mass comprising at least one bridge of material of variable width,
(b) Assemble the rotor mass on the rotor shaft, by fitting, in particular by force insertion or by shrink-fitting.

The bridge(s) of the material may undergo elastic and/or plastic deformation when the rotor mass is inserted onto the shaft, in particular elastic and plastic deformation.

During the assembly step (b), the rotor mass can be moved along the axis of rotation X relative to the shaft. The rotor mass may be kept stationary and the shaft may be threaded into the rotor mass, or alternatively the shaft may be kept stationary and the rotor mass may be threaded onto the shaft. The force required for insertion is reduced, particularly compared to a rotor which requires a clamping system for assembly. In addition, centering is easier, as is angular alignment of the rotor poles. Insertion is made easier, as is the assembly method. The number of operations necessary to implement the method can be reduced, as well as the need for auxiliary tools.

### BRIEF DESCRIPTION OF THE DRAWINGS

The described methods and devices will be better understood on reading the following detailed description of non-limiting examples of implementation thereof, and on examining the appended drawing, wherein:

FIG. 1 is a schematic and partial cross-sectional view of a rotor mass made.

FIG. 2 is a detailed view of a bridge of material of the rotor mass of FIG. 1.

FIG. 3 is a view similar to FIG. 2.

FIG. 4 is a view similar to FIG. 2.

FIG. 5 is a schematic and partial view of the assembly of the rotor mass of FIG. 1 on a shaft.

FIG. 6 is a view similar to FIG. 1 of an alternative embodiment.

FIG. 7 is a view similar to FIG. 1 of an alternative embodiment.

FIG. 8 is a schematic and partial cross-sectional view of the edge of the central bore of a rotor mass according to an alternative embodiment.

FIG. 9 is a schematic and partial perspective view of a rotor mass according to an alternative embodiment.

FIG. 10 is a view similar to FIG. 1 of an alternative embodiment.

### DETAILED DESCRIPTION

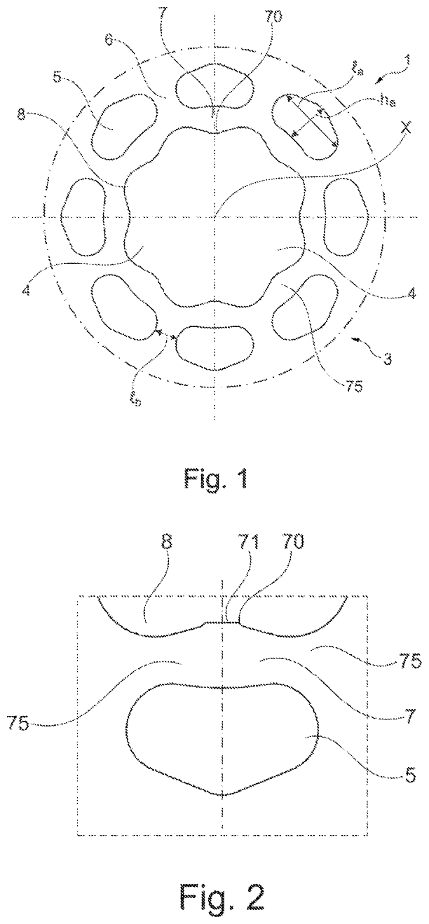

FIGS. 1 to 4 show an inner rotor 1 of a rotary electric machine, also including an outer stator not shown. The stator makes it possible to generate a rotating magnetic field for rotating the rotor 1, in the context of a synchronous motor, and in the case of an alternator, the rotation of the rotor induces an electromotive force in the windings of the stator.

The rotor 1 shown in FIG. 1 includes a rotor mass 3 extending axially along the axis of rotation X of the rotor, this rotor mass being for example formed by a magnetic lamination stack stacked along the axis X, the laminations for example being identical and exactly superimposed. They can be held together by clipping, by rivets, by tie rods, by welds or any other technique. The magnetic laminations are preferably made of magnetic steel. All of the magnetic steel shades can be used.

The rotor mass 3 comprises a central bore 4 for mounting on a shaft not shown. In the example considered, the shaft can be made of a non-magnetic material, for example non-magnetic stainless steel, or on the contrary be magnetic.

The rotor mass has openings 5 equally distributed circumferentially around the central bore 4. The openings have a larger circumferential dimension lₒ and a larger radial dimension hₒ. The largest circumferential dimension lₒ is greater than the largest radial dimension hₒ. In the example shown, the openings 5 are all identical and each opening is symmetrical with respect to a radial plane containing the axis X of rotation.

The openings 5 leave radial strips 6 therebetween. The radial strips are of variable width and have a smaller width lb. In the example illustrated, the smallest width l_{b} of the radial strips is of the order of 5 mm.

Bridges of material 7 are provided between the openings 5 and the central bore 4. These bridges of material are of variable width. They have a larger width lₚₘₐₓ and a smaller width lₚₘᵢₙ. In the example shown, the largest width lₚₘₐₓ is of the order of 5 mm and the smallest width lₚₘᵢₙis of the order of 3.7 mm. The ratio between the largest width lₚₘₐₓ and the smallest width lₚₘᵢₙ is, in this example, of the order of 1.35.

The smallest width l_{b} of the radial strip 6 is substantially equal to the largest width lₚₘₐₓ of the bridge of material 7 provided by one of the openings 5 leaving the radial strip 6 in the example of FIGS. 1 to 4. The ratio between the smallest width of the radial strip l_{b} and the largest width of the bridge of material lₚₘₐₓ is of the order of 1. This allows sufficient deformation of the bridge of material to allow the rotor mass to be inserted on the shaft.

The bridges of material 7 are all substantially symmetrical with respect to a plane comprising the axis of rotation X. The plane of symmetry of each bridge of material 7 meets with the plane of symmetry of the opening 4 which provides the bridge of material. The plane containing the larger width of the bridge of material may meet with the plane of symmetry of the latter.

Each bridge of material 7 comprises areas of smaller width on either side of its larger width 75. Thus, each bridge of material has a widened portion surrounded on either side by a thin portion.

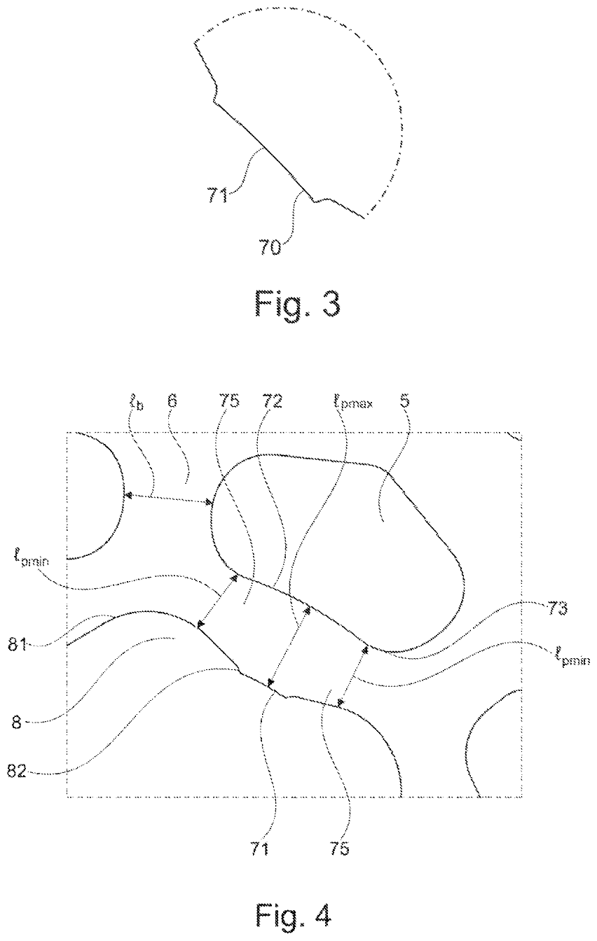

In the example shown, each bridge of material 7 comprises a tongue 70 arranged between the narrowest width zones 75. As is more particularly visible in FIGS. 3 and 4, the edge 71 of the tongue 70 on the side of the central bore 4 is slightly convex. The edge 72 of the tongue 70 on the opening side 5 is concave.

In this example, the tongue 70 is shrink-fitted onto the shaft when it is inserted into the central bore. The circumferential dimension of the tongue is around 3 mm.

The variations in the width of the bridge of material 7 form recesses 8 around the larger width lₚₘₐₓ of the bridge of material 7 on the side of the central bore. In the example shown, the recesses 8 have a crescent shape. In the example shown, the recesses 8 have a circular edge 81 with a radius of curvature of around 5 mm. The edge 82 creating the junction between a recess 8 and the tongue 70 is curved and has a radius of curvature of the order of 0.35 mm.

The internal circumference of an opening 5 includes curved portions and straight portions. In the example illustrated, the curved portions of the internal circumference of the opening which delimit the edges 73 of the areas of smaller width of a bridge of material 7 have a radius of curvature of the order of 3 mm.

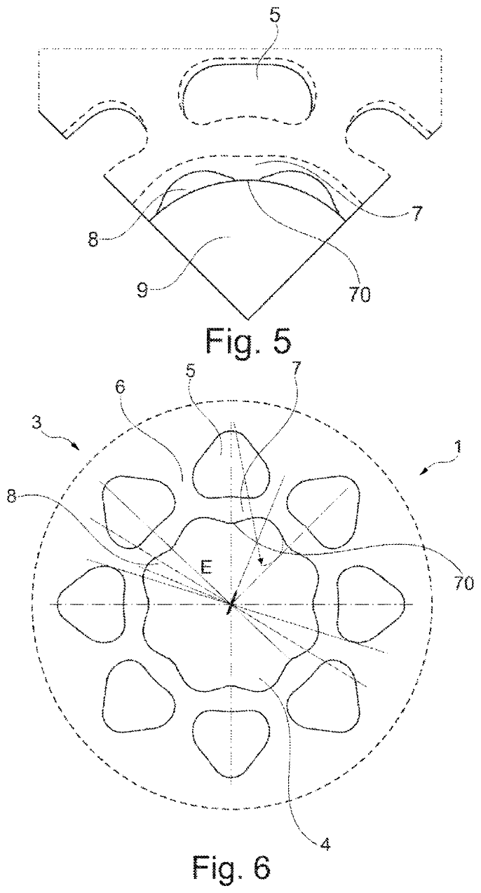

FIG. 5 illustrates a rotor mass 3, shrink-fitted onto a shaft 9. The tongue 70 deforms out of a plane perpendicular to the axis of rotation X without bending.

Furthermore, the bridge of material is also deformed in the plane perpendicular to the axis of rotation of the rotor and which contains the bridge of material. In particular, the bridge of material deforms and moves into the corresponding opening 5 during fitting.

The dotted lines illustrate, in an exaggerated manner, the deformation of the lamination due to the centrifugal force when the rotor rotates at high speeds.

The recesses 8 provide a free space wherein a cooling fluid can circulate.

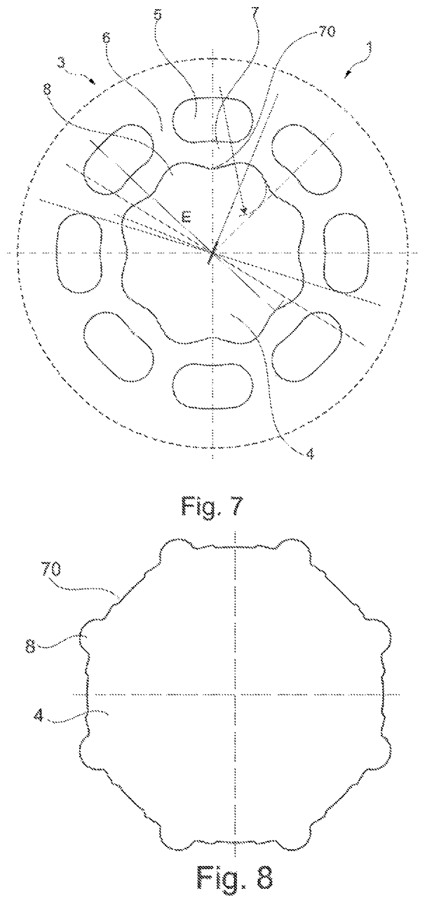

FIGS. 6 and 7 illustrate alternative embodiments wherein the shapes of the openings 5 differ. In the two embodiments shown, the openings have straight edges and curved edges. In the embodiment of FIG. 6, the openings are substantially triangular in shape. In the embodiment of FIG. 7, the openings are substantially trapezoidal in shape.

FIG. 8 illustrates an embodiment wherein the shape of the recesses 8 differs from the embodiments of FIGS. 1 to 7. In the embodiments of FIGS. 1 to 7, the recesses have a crescent shape. In the embodiments of FIG. 8, the recesses 8 are circular.

The different shapes of openings 5 and recesses 8 presented allow sufficient deformation of the bridge of material to allow the rotor mass to be fitted onto the shaft. Other embodiments to those shown may be suitable.

FIG. 9 shows a first stack of laminations 3 and a second stack of laminations 31b of a stack of laminations forming the rotor mass 3. The laminations of the two stacks of laminations are identical to each other and are the same as those shown in FIGS. 1 to 5. The first and second stacks of laminations are angularly offset by an angle of around 3.75°. Thus, the tongues 70a of the laminations of the first stack of laminations are not aligned with the tongues 70b of the laminations of the second stack of laminations.

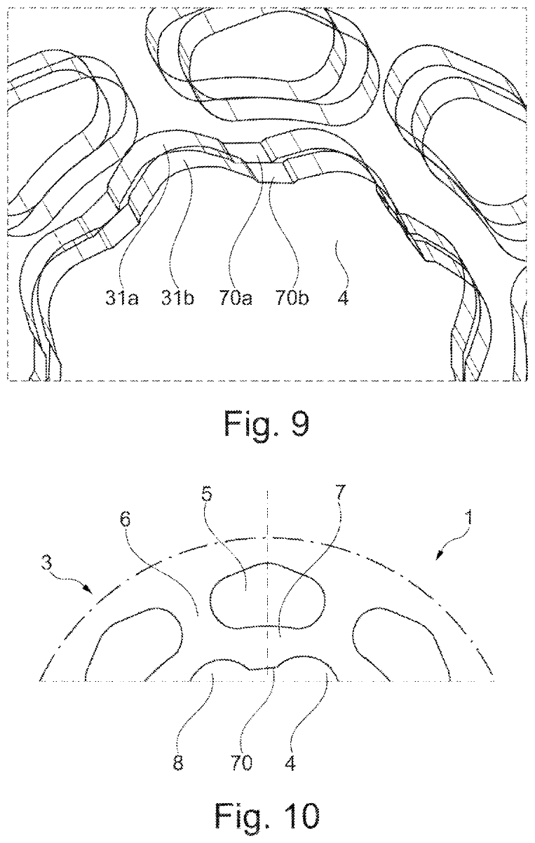

In the embodiment of FIG. 10, the plane of symmetry of the tongue 70 does not meet the plane of symmetry of the bridge of material nor a plane of symmetry of the opening. The tongue can, for example, be offset by 10° relative to a plane of symmetry of the opening.

Of course, the described methods and devices are not limited to the exemplary embodiments that have just been described. For example, the number of bridges of material and/or openings can vary and they may have different shapes.

1.-16. (canceled)

17. A rotor of an electric machine, rotating about an axis of rotation (X), the rotor comprising:
a shaft arranged along the axis of rotation (X),
a rotor mass, extending along the axis of rotation (X) and disposed around the shaft, the rotor mass comprising:
-a central bore for the passage of the shaft,
at least two openings, provided in the rotor mass and distributed circumferentially around the central bore, the two openings leaving a radial strip therebetween, the radial strip having a smaller width (l_{b}),
at least one bridge of material being provided between an opening and the central bore, the bridge of material being of variable width and having a greater width (lₚₘₐₓ) and a smaller width (lₚₘᵢₙ), and having on either side of its greater width (lₚₘₐₓ) areas of smaller width, and the ratio between the smaller width of the radial strip (l_{b}) and the larger width of the bridge of material lₚₘₐₓ) being between 0.75 and 1.25.

18. A rotor of an electric machine, rotating about an axis of rotation (X), the rotor comprising:
a shaft arranged along the axis of rotation (X),
a rotor mass, extending along the axis of rotation (X) and disposed around the shaft, the rotor mass comprising:
a central bore for the passage of the shaft,
at least two openings, the openings being all identical, provided in the rotor mass and distributed circumferentially around the central bore, the two openings leave a radial strip therebetween, the radial strip having a smaller width (l_{b});
at least one bridge of material being provided between an opening and the central bore, the bridge of material being of variable width and having a greater width (lₚₘₐₓ) and a smaller width (lₚₘᵢₙ), and the ratio between the smaller width of the radial strip (l_{b}) and the larger width of the bridge of material (lₚₘₐₓ) being between 0.75 and 1.25.

19. The rotor according to claim 18, the bridge of material comprising areas of smaller width on either side of its larger width (lₚₘₐₓ).

20. The rotor according to claim 17, the ratio between the larger width (lₚₘₐₓ) of a bridge of material and the smaller width (lₚₘᵢₙ) of a bridge of material being between 1.10 and 3.00.

21. The rotor according to claim 17, a bridge of material comprising one or more tongues (70) arranged between the areas of smaller width.

22. The rotor according to claim 21, the tongue being shrink-fitted onto the shaft.

23. The rotor according claim 21, a circumferential dimension of the tongue being between 1 and 40% of the diameter of the central bore.

24. The rotor according to claim 23, the circumferential dimension of the tongue being of the order of 9% of the diameter of the central bore.

25. The rotor according to claim 17, the shaft being substantially smooth.

26. The rotor according to claim 24, the shaft being devoid of surface roughness.

27. The rotor according to claim 17, the variations in width of the bridge of material forming recesses around the larger width (lₚₘₐₓ) of the bridge of material.

28. The rotor according to claim 17, the variations in width of the bridge of material forming recesses around the larger width (lₚₘₐₓ) at the edge of the central bore.

29. The rotor according to claim 17, the rotor mass being formed of a stack of laminations forming stacks.

30. The rotor according to claim 29, the rotor mass being formed of a stack of laminations at least identical on the side of the shaft.

31. The rotor according to claim 30, at least a first and a second stack of laminations of the stack of laminations being angularly offset such that the tongues of the bridges of material of the first stack are not aligned with the tongues of the bridges of material of the second stack.

32. The rotor according to claim 17, the openings having a larger circumferential dimension of between 5 mm and 100 mm.

33. A rotary electric machine comprising a rotor according to claim 17 and a stator.

34. The machine according to claim 33, the stator comprising electrical conductors, at least some of the electrical conductors, or even most of the electrical conductors, being in the form of U- or I-shaped pins.

35. A method of manufacturing a rotor according to claim 17, comprising the following steps:
(a) Provide a rotor shaft and a rotor mass comprising at least one bridge of material of variable width,
(b) Assemble the rotor mass on the rotor shaft, by shrink-fitting.

36. The method according to claim 35, the bridge(s) of material undergoing elastic and/or plastic deformation when the rotor mass is inserted onto the shaft
